(19) United States
(12) Patent Application Publication
(10) Pub. No.: US 2026/0087391 A1
(43) Pub. Date: Mar. 26, 2026

(54) MULTIPLEXED INPUT IN A QUANTUM COMPUTING CIRCUIT

(71) Applicant: IQM FINLAND OY, Espoo (FI)

(72) Inventors: Kristinn JULIUSSON, Espoo (FI); Brian TARASINSKI, Espoo (FI)

(21) Appl. No.: 19/110,975

(22) PCT Filed: Sep. 14, 2022
(86) PCT No.: PCT/FI2022/050618

§ 371 Date: Mar. 12, 2025

(51) Int. Cl. G06N 10/40; G06N 10/20

(52) U.S. Cl. CPC G06N 10/40; G06N 10/20

(57) ABSTRACT

This disclosure describes a quantum computing circuit comprising a set of qubits. The circuit comprises drivelines for addressing the qubits. The drivelines comprise one or more x-drivelines and one or more y-drivelines which form a grid. The quantum computing circuit comprises a set of bandpass filters, coupled between the drivelines and the set of qubits so that each qubit is coupled to one x-driveline and to one y-driveline with a bandpass filter.

### FIELD OF THE DISCLOSURE

This disclosure relates to quantum computers, and more particularly to input arrangements for addressing qubits in a quantum computing circuit.

### BACKGROUND OF THE DISCLOSURE

Qubits can be implemented as superconducting circuits resonating at microwave frequencies where the quantum levels of the circuit have unique separations. Two levels, typically the lowest two, can then be considered as a qubit and controlled without influencing other levels of the circuit.

Qubits can be controlled by an electric field coming from dedicated transmission lines called drivelines and are capacitively coupled to it. The electric field or signal in the drivelines is generated by a signal generator and can drive a qubit into a desired quantum state.

A quantum circuit may contain an unlimited number of qubits. It is important that a signal which is intended for changing the state of a selected qubit does not interfere with other qubits in the circuit. In other words, it should be possible to address qubits individually by changing the state of a selected qubit without altering the states of other qubits.

It is known from the prior art that qubits can be individually addressed if each qubit is coupled to its own control line. A general challenge in systems with multiple control lines is that crosstalk between the control lines needs to be avoided. When the number of qubits becomes large and each qubit is connected to its own control line, a lot of space is needed for accommodating the entire circuit and accounting for crosstalk becomes increasingly difficult.

### BRIEF DESCRIPTION OF THE DISCLOSURE

An object of the present disclosure is to provide an improved apparatus and method for controlling qubits in a quantum circuit.

The object of the disclosure is achieved by what is stated in the independent claims. The preferred embodiments of the disclosure are disclosed in the dependent claims.

The disclosure is based on the idea of multiplexed drivelines. Each qubit is connected to multiple drivelines and controlled through these drivelines. An advantage of this arrangement is that it facilitates a compact quantum circuit where any combination of qubits can be simultaneously addressed.

### BRIEF DESCRIPTION OF THE DRAWINGS

In the following the disclosure will be described in greater detail by means of preferred embodiments with reference to the accompanying drawings, in which

FIGS. 1a-1b illustrate quantum computing circuits with one and four qubits, respectively.

FIGS. 2a-2b illustrate quantum computing circuits with larger arrays of qubits.

FIGS. 3 and 4 illustrate quantum computing circuits which include z-drivelines.

FIG. 5 illustrates a method for addressing one or more target qubits in the set of qubits.

### DETAILED DESCRIPTION OF THE DISCLOSURE

This disclosure describes a quantum computing circuit comprising a set of qubits. Each qubit in the set has an excitation frequency. The quantum computing circuit comprises drivelines for addressing the qubits in the set and one or more signal-generating units for generating a qubit-addressing signal in each driveline.

The drivelines comprise one or more x-drivelines and one or more y-drivelines. The quantum computing circuit comprises a set of bandpass filters. The set of bandpass filters comprises a set of x-bandpass filters coupled between the one or more x-drivelines and the set of qubits and a set of y-bandpass filters coupled between the one or more y-drivelines and the set of qubits, so that each qubit in the set of qubits is coupled to one x-driveline with one x-bandpass filter and to one y-driveline with one y-bandpass filter.

This disclosure also describes a method where one or more target qubits belonging to the set of qubits in the quantum computing circuit are addressed simultaneously. The target qubits are addressed by generating with the one or more signal-generating units a first qubit-addressing signal in each of the one or more x-drivelines to which one of the one or more target qubits is coupled and generating a second qubit-addressing signal in each of the one or more y-drivelines to which one of the one or more target qubits is coupled, so that each of the one or more target qubits is simultaneously driven by one first qubit-addressing signal and one second qubit-addressing signal.

This disclosure also describes a quantum computer or quantum computing system comprising a quantum-computing circuit according to any embodiment presented in this disclosure.

In this disclosure the terms “x-driveline”, “y-driveline” and “z-driveline” distinguish three sets of drivelines from each other. In embodiments where only x- and y-drivelines are present, each x-driveline+y-driveline pair is coupled to one and only one qubit in the set of qubits. In other words, no two qubits in the set are coupled both to the same x-driveline and to the same y-driveline. In embodiments where a z-drivelines are also present, two qubits in the set may be coupled to the same x-driveline and the same y-driveline, but they will then be coupled to different z-drivelines. Each x-driveline+y-driveline+z-driveline triplet is therefore coupled to one and only one qubit in the set, and no two qubits are coupled to the same x-driveline, same y-driveline and same z-driveline.

In any embodiment of this disclosure, the drivelines may be arranged in a grid, and the set of qubits may be arranged in an array. The geometry of the array may be defined by the grid geometry. All sets of drivelines (x, y and z) can be oriented in any direction, so x-drivelines do not need to be orthogonal to y-drivelines (even though they are illustrated as orthogonal in some figures of this disclosure). Furthermore, all drivelines which belong to one set (x, y, or z) do not necessarily have to be parallel with each other, even though they are depicted as parallel in the figures of this disclosure.

The drivelines described in this disclosure may be formed by any electric conductor which can be used in a quantum computing circuit. Drivelines may be formed with materials which can be made superconducting, but other conductive materials may also be used. Drivelines may have a flat frequency spectrum, and they may transmit signals at all frequencies. All drivelines are electrically isolated from each other, even though they intersect in the schematic drawings of this disclosure.

Signal-generating units are not illustrated in the figures of this disclosure. A signal-generating unit may be any kind of unit which can generate signals at microwave frequencies. It is assumed in all figures of this disclosure that one or more signal-generating units are connected to each driveline illustrated in the figure.

In any embodiment presented in this disclosure, all qubits in the set of qubits may have the same excitation frequency. Alternatively, the excitation frequencies of some qubits in the set of qubits may differ from the excitation frequencies of other qubits in the set of qubits.

All bandpass filters (x, y and z) presented in this disclosure transmit electromagnetic signals which fall within their bandpass frequency range and do not transmit signals which fall outside of that range. As explained in more detail below, the bandpass filters included in the quantum computing circuit can have different bandpass frequency ranges. The bandpass filters described in this disclosure may for example be resonators. Examples of resonators include waveguide which have a length equal to half the wavelength of the signal which is intended to be transmitted through the resonator. Only signals which create a standing resonating wave in the waveguide can pass through to the qubits.

In this disclosure the terms “x-bandpass filter”, “y-bandpass filter” and “z-bandpass filter” distinguish three sets of bandpass from each other based on the drivelines to which they are connected. There is no other categorical difference between the x-, y- and z-drivelines. As explained in more detail below, each of the three sets may contain bandpass filters with different passband frequency ranges.

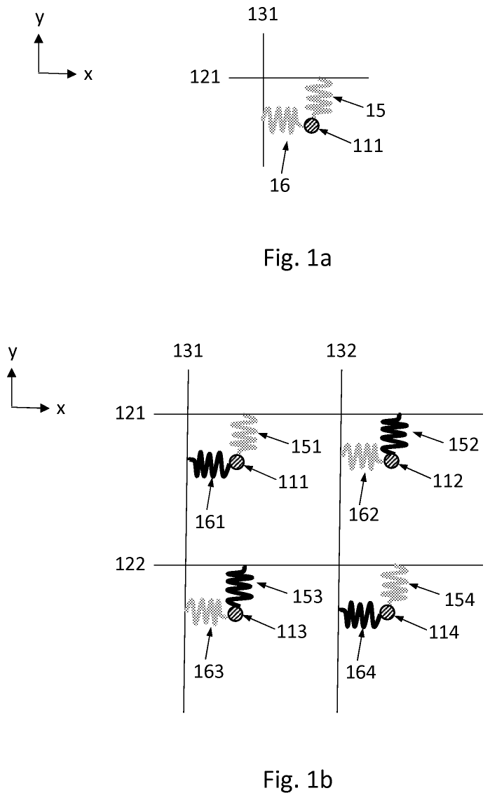

The set of qubits may comprise any number of qubits. The operation of the device will be explained with reference to FIG. 1a, which illustrates schematically a quantum computing circuit with a set of qubits which comprises one qubit 111. This qubit has an excitation frequency F, so it can be addressed (i.e. driven to change its state) with photons whose energies add up to this frequency. The circuit also comprises an x-driveline 121 and a y-driveline 131, and x-bandpass filter 15 and a y-bandpass filter 16. The x-bandpass filter 15 is connected between the x-driveline 121 and the qubit 111, while the y-bandpass filter 16 is connected between the y-driveline 131 and the qubit 111. All x- and y-drivelines in the quantum computing circuit may, but do not necessarily have to, lie in the same plane. This plane may be called the driveline plane. The driveline plane is illustrated as the xy-plane in this disclosure.

A qubit-addressing signals can be generated in each driveline with a signal-generating unit. The qubit-addressing signal which is sent through a driveline can contain one or more signal components. Each signal component has its own frequency, which may be called a qubit drive tone.

Each bandpass filter has a predetermined passband. A filter which is coupled between a driveline and a qubit allows a signal to pass from the driveline to the qubit only if the frequency of the signal falls within the passband of the filter. Signals with frequencies which do not fall within the passband of the filter do not pass through.

For example, if a qubit-addressing signal in x-driveline 121 contains a signal component whose qubit drive tone falls within the passband of the x-bandpass filter 15, then that qubit-addressing signal can reach the qubit 111. If the bandpass filter 15 is a resonator, the qubit-addressing signal can create a resonating signal in 15 only if it contains a component whose frequency corresponds to the resonance frequency of the resonator.

The same considerations apply also to the y-driveline 131 and the y-bandpass filter 16. The qubit 111 can therefore be reached by photons arriving both from the x-driveline 121 and the y-driveline 131. The x- and y-bandpass filters also protect the qubits from Purcell decay into the corresponding driveline.

The state of the qubit 111 can be changed by the qubit-addressing signal in x-driveline 121 and the qubit-addressing signal in y-driveline 131 when these two signals are applied simultaneously. The qubit-addressing signal in x-driveline 121 may contain a component with a first qubit drive tone which falls within the passband of the x-bandpass filter 15, and the qubit-addressing signal in x-driveline 131 may contain a component with a second qubit drive tone which falls within the passband of the y-bandpass filter 16. These first and second qubit drive tones may differ from each other, or they may equal. In other words, the passbands of filters 15 and 16 may differ from each other, or they may be equal.

Photons which reach the qubit 111 through the x- and y-bandpass filters and whose frequencies add up to the qubit frequency F can drive the qubit. If, for example, the power of the signal-generating units are set so that two photons which have the frequency of a first qubit drive tone QDT1 can pass from the x-driveline through the x-bandpass filter 15 while one photon which has the frequency of a second qubit drive tone QDT2 passes from the y-driveline 131 through the y-bandpass filter 16 to the qubit 111, then the state of the qubit 111 can be changed if the condition 2*QDT1+QDT2=F is met, where F is the excitation frequency of the qubit 111. On the other hand, if two photons reach the qubit 111 through the y-bandpass filter 16 while one photon reaches the qubit 111 through the x-bandpass filter 15, the condition becomes QDT1+2*QDT2=F. If two photons pass through both filters 15 and 16, the condition is 2*QDT1+2*QDT2=F.

In general, a qubit can be addressed by two or more qubit-addressing signals entering from different drivelines if a weighted sum of photon frequencies, where each weight is the number of photons which reach the qubit with that frequency, is equal or substantially equal to the excitation frequency of the qubit.

Three-photon driving will be used as an example in the embodiments of this disclosure, but excitation with more than three photons could alternatively be used. In general, the qubit can be addressed simultaneously by the qubit-addressing signals in the x- and y-drivelines (and, in some embodiments, the additional z-driveline) if the frequencies of the photons which pass through the x- and y-bandpass filters (and, in some embodiments, the additional z-driveline) to the qubit add up to the excitation frequency of the qubit.

Multi-photon driving is possible when the qubit has non-linear interaction with the drive field. The rate of such drives depends on the strength of the non-linear interaction and is subject to selection rules and energy conservation. For further information see e.g. chapter 9 of Elements of Quantum Optics by Pierre Meystre and Murray Sargent.

This operating mechanism applies to all embodiments presented in this disclosure. As the number of qubits increases, the arrangements needed for simultaneously addressing any combination of qubits in the circuit become more complex.

FIG. 1b illustrates a circuit with four qubits 111-114 arranged in an array configuration. The circuit contains a first x-driveline 121 and a second x-driveline 122, and a first y-driveline 131 and a second y-driveline 132. Each qubit is connected to one x-driveline with an x-bandpass filter (151-154) and to one y-driveline with a y-bandpass filter (161-164). Each qubit is connected to a unique x, y-driveline pair (i.e. no two qubits are connected to the same pair). The colour of the bandpass filter illustrates its passband. Grey bandpass filters (151, 154, 162 and 163) transmit photons which have the frequency of a first qubit drive tone QDT1, while black bandpass filters (152, 153, 161 and 164) transmit photons which have the frequency of a second qubit drive tone QDT2. The first and second qubit drive tones are different, so the passbands of the black and grey bandpass filters must also be different.

The qubit-addressing signals generated in x-drivelines 121-122 and in y-drivelines 131-132 may now comprise one or two frequency components. These components are the first qubit drive tone QDT1, which can reach any qubit connected to the driveline in question with a grey bandpass filter, and the second qubit drive tone QDT2, which can reach any qubit connected to a driveline with a black bandpass filter. If, for example, one would like to simultaneously address qubits 111, 113 and 114, but not qubit 112, the qubit-addressing signals could comprise the following components:
121: QDT1
122: QDT1 and QDT2
131: QDT1 and QDT2
132: QDT2

All qubits 111-114 may have the same excitation frequency F. All qubits 111-114 and corresponding bandpass filters are configured like qubit 111 in FIG. 1a. In other words, the passbands of the filters are matched to the excitation frequency of the qubit so that the qubit is addressed only if photons simultaneously reach the qubit both from the x-driveline and from the y-driveline to which it is connected. Consequently, as an alternative to the previous example, either one of signals 121 or 132 might alternatively comprise both components QDT1 and QDT2, but since the intention is to leave qubit 112 unaddressed, both of these signals 121 and 132 cannot comprise both components.

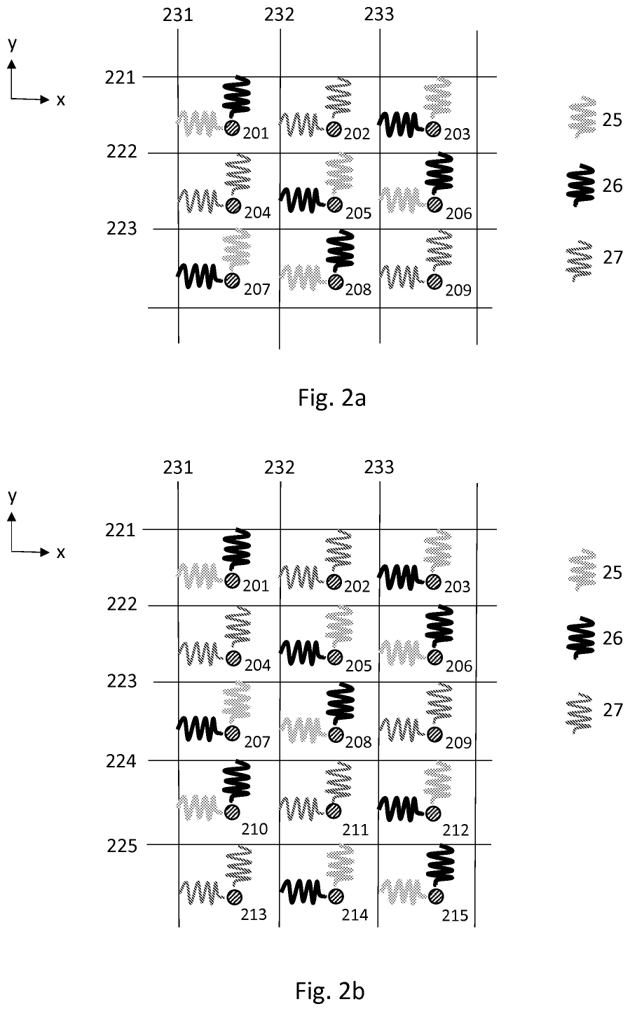

FIG. 2a illustrates an array with nine qubits 201-209, all of which may have the same excitation frequency F. The circuit comprises three x-drivelines 221-223 and three y-drivelines 231-233. The circuit also comprises three different kinds of bandpass filters, the thick grey one 25, the black one 26 and the thin grey one 27. The passbands of these three kinds of bandpass filters differ from each other.

As in the previous example, the passbands of the filters 25-27 are matched to the excitation frequency of the qubits 201-209 so that the qubit is addressed only if photons simultaneously reach the qubit both from the x-driveline and from the y-driveline to which it is connected. Thick grey bandpass filters 25 transmit photons which have the frequency of a first qubit drive tone QDT1, black bandpass filters 26 transmit photons which have the frequency of a second qubit drive tone QDT2, and thin grey bandpass filters 27 transmit photons which have the frequency of a third qubit drive tone QDT3.

As in the previous examples, a qubit can be driven simultaneously by the qubit-addressing signals in the x- and y-drivelines to which it is connected if the frequencies of the photons which pass through x- and y-bandpass filters 15 and 16 add up to the resonance frequency of the qubit.

If three photons are used for driving the qubit, then the frequencies of the photons which are transmitted to a qubit which is connected to drivelines with a thick grey (25) and a black (26) bandpass filter may for example exhibit the relationship 2*QDT1+QDT2=F when the qubit-addressing signals are such that two photons are expected to be transmitted through the thick grey bandpass filter when one photon is transmitted through the black filter. The magnitude of QDT1 may for example be QDT1=(F+d)/4 and the magnitude of QDT2 may be QDT2=(F−d)/2, where d is any value between zero and F/2. Other options are also possible. Correspondingly, the frequencies of the photons which are transmitted to a qubit which is connected to both drivelines with thin grey (27) bandpass filters may for example exhibit the relationship 3*QDT3=F. If more than three photons are used to address a qubit, the magnitudes of the qubit drive tones could be selected in many different ways. The optimal selection will depend both on the excitation frequencies of the qubits in the circuit and on the passband frequencies and pass bandwidths of the filters.

As in the previous example, any combination of qubits selected from the group 201-209 can be simultaneously addressed by generating in each x-driveline 221-223 and in each y-driveline 231-233 qubit-addressing signals which comprise the qubit drive tones which transmit photons to the selected qubits which are coupled to that driveline.

Furthermore, the array illustrated in FIG. 2a can be expanded further either in the x- or y-direction so that it for example includes an unlimited number of rows and three columns. FIG. 2b illustrates an array with five rows and three columns, and any number of additional rows could be added. The array in FIG. 2b comprises fifteen qubits 215, all with the same excitation frequency. Again, any combination of qubits selected from the group 201-209 can be simultaneously addressed because the qubit-addressing signals generated in x-drivelines 221-225 will always address each qubit coupled to that x-driveline at a frequency which will have no effect on the other qubits connected to that x-driveline. Alternatively, the array in FIG. 2a could be expanded with more columns (while keeping the number of rows at three). This option has not been separately illustrated, but the same control could in that case be exercised through the y-drivelines 231, 232, 233 etc.

The number of qubit drive tones carried by any driveline is not limited to two or three in any embodiment of this disclosure, even though these numbers have been used in the examples shown in FIGS. 1b and 2a-2b. The array shown in FIG. 2a could for example be expanded to include four rows and four columns, and a fourth qubit drive tone could be added to the circuit to facilitate unique addressing of all possible qubit combinations in the circuit. The passband widths which are required for the bandpass filters to work as intended may place some practical limitations on the number of qubit drive tones that can be employed in one qubit-addressing signal. Nevertheless, signals with at least five different qubit drive tones may be used to address an array of qubits where all qubits have the same excitation frequency. If qubits with different excitation frequencies are connected to the same driveline, the number of drive tones may be even greater.

In any embodiment of this disclosure, the set of qubits in the quantum computing circuit may alternatively comprise a first subset of qubits which have a first excitation frequency F1 and a second subset of qubits which have a second excitation frequency F2. F1 is different from F2. This option has not been separately illustrated. If the qubits illustrated in FIG. 2a form a first subset, then the second subset could for example comprise nine additional qubits which are added to the array in FIG. 2a and coupled to x-drivelines 221-223 and to three additional y-drivelines. The qubit-addressing signals in x-drivelines 221-223 may then comprise the three qubit drive tones QDT1-QDT3 mentioned above and three additional qubit drive tones QDT4-QDT6 which would be used to address the second subset of qubits. The qubit-addressing signals in the three additional drivelines would comprise the three additional qubit drive tones. This array comprising a first and a second subset of qubits arranged in six columns expanded with an unlimited number of rows, just like the one in FIG. 2a, and any combination of qubits in the array could still be uniquely addressed.

In any embodiment of this disclosure, the set of qubits may comprise one or more subsets, so that the qubits in a first subset have a first excitation frequency F1 and the qubits in the optional second, third, fourth, n:th subsets have corresponding excitation frequencies F2, F3, F4, and Fn. These excitation frequencies F1-Fn may all be different from each other, and all of them may for example lie in the range 3 GHz-8 GHz, or in the range 1-100 GHz. When the excitation frequencies are ordered based on their magnitude, the difference between each pair of adjacent excitation frequencies may for example be greater than 200 MHz. Furthermore, in any embodiment of this disclosure, if all passband frequencies of bandpass filters connected to the same driveline are ordered based on magnitude, the difference between the centers of each pair of adjacent passband frequencies may be greater than 125 MHz or greater than 150 MHz to ensure that drive tones do not accidentally pass through the wrong filter. The width the passband of any bandpass filter described in this disclosure may for example be in the range 20 MHz-100 MHz.

In addition to the x- and y-drivelines discussed above, the drivelines in the quantum computing circuit may also comprise one or more z-drivelines, and the set of bandpass filters may also comprise a set of z-bandpass filters coupled between the one or more z-drivelines and the set of qubits, so that each qubit in the set of qubits is also coupled one z-driveline with one z-bandpass filter.

Correspondingly, the method for simultaneously addressing one or more target qubits in the set of qubits may comprise the step of generating with the one or more signal-generating units a third qubit-addressing signal in each of the one or more z-drivelines to which one of the one or more target qubits is coupled, so that each of the one or more the target qubits is simultaneously driven by one first qubit-addressing signal, one second qubit addressing signal and one third qubit-addressing signal.

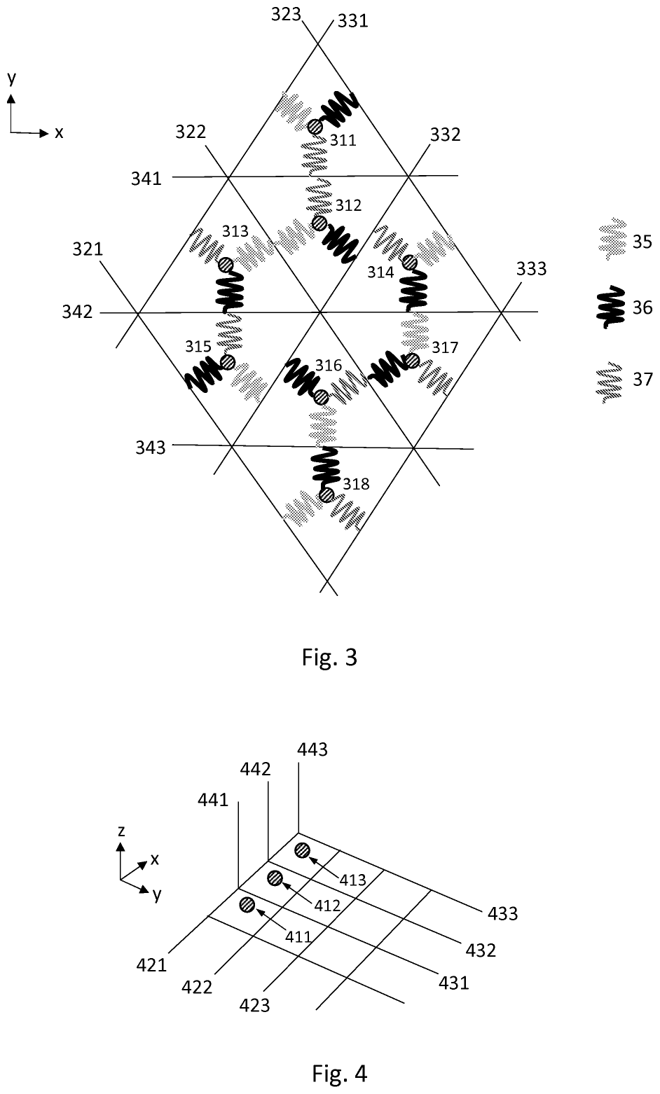

A first example of a circuit which includes z-drivelines is shown in FIG. 3. This circuit is arranged in a planar or substantially planar configuration where the one or more x-drivelines, the one or more y-drivelines and the one or more z-drivelines lie in a driveline plane. The driveline plane may correspond to a two-dimensional surface, for example the surface of a substrate. The illustrated drivelines comprise x-drivelines 321-323, y-drivelines 331-333 and z-drivelines 341-343 which form a triangular pattern in the driveline plane. Each qubit 311-318 in the quantum computing circuit may be placed inside a triangle and coupled to one x-driveline, one y-driveline and one z-driveline with one bandpass filters 35-37.

As in the previous examples, each bandpass filter 35-37 has a passband which only allows photons of a certain frequency to pass through to the qubit. The passbands of filters 35-37 differ from each other. Any selected qubit in the circuit can be addressed for by generating suitable qubit-addressing signals in the x-, y- and z-drivelines to which that qubit is coupled. Each of these signals should comprise a qubit drive tone with a frequency which falls within the passband of the filter which coupled the selected qubit to the driveline in question. The state of the selected qubit can be changed when one photon from each driveline (x, y and z) are simultaneously transmitted to selected qubit.

The frequencies of the photons which are transmitted to a qubit in FIG. 3 may be called QDT1, QDT2 and QDT3, as in the earlier example. The passband of the thick grey (35) bandpass filter could for example correspond to QDT1, while the passbands of the black (36) and thin grey (37) bandpass filters could correspond to QDT2 and QDT3, respectively. The excitation frequency of the selected qubit may be labelled F, as in the previous examples. The sum of qubit drive tones QBT1+QBT2+QBT3 is substantially equal to the excitation frequency F. The magnitude of QDT1 may for example be QDT1=(F/3)+3d, the magnitude of QDT2 may be QDT2=(F/3)−2d and the magnitude of QDT3 may be QDT3=(F/3)−d, where d may be any value between zero and F/6. Other options are also possible and many more alternatives are available if more than three photons are used to address each qubit. The optimal selection will depend both on the excitation frequencies of the qubits in the circuit and on the passband frequencies and pass bandwidths of the filters.

As in the preceding example, any combination of qubits in the array can be uniquely addressed if one dimension of the array is limited by the number of qubit drive tones. The other two dimensions can be expanded without limit. If, for example, the number of qubit drive tones is three in FIG. 3, then any combination of qubits could be uniquely addressed if the number of x-drivelines 321-323, for example is limited to three. The number of y-drivelines and z-drivelines would not have to be limited. If the number of qubit drive tones would be four, then the number of x-drivelines would be limited to four, and so on.

More generally, and this applies to the preceding example as well, if the set of qubits comprises M subsets of qubits, and the number of qubit drive tones which is utilized for driving the i:th subset is Nᵢ, then the number of drivelines in one dimension (e.g. x, y or z) should be limited to the sum of Nᵢ:s from all the M subsets, while the number of drivelines can be unlimited in the other dimensions.

A second example of a circuit which includes z-drivelines is shown in FIG. 4. X-drivelines are indicated with reference numbers 421-423, y-drivelines are indicated with 431-433 and z-drivelines with 441-443. Here the z-drivelines do not lie in the same plane as the x- and y-drivelines. They are instead oriented perpendicularly to the driveline plane. If the driveline plane corresponds to the surface of a substrate, the z-driveline may be built above the surface so that the circuit is three-dimensional. In general, the one or more x-drivelines and the one or more y-drivelines may lie in a driveline plane, and the one or more z-drivelines may extend against the driveline plane at nonzero angles. It may be noted that drivelines can be arranged in many different geometric configurations in all embodiments of this disclosure. All x-drivelines, for example, do not have to be parallel with each other. Furthermore, even a circuit which utilizes just x-drivelines and y-drivelines can be three-dimensional, since some x- or y-drivelines can lie on a substrate surface while other x- or y-drivelines can extend out of the plane defined by that surface. As mentioned before, the letters x, y and z merely distinguish three different sets of drivelines (and corresponding sets of bandpass filters) from each other. The x-drivelines could equally well be called first drivelines, the y-drivelines could be called second drivelines, and the z-drivelines could be called third drivelines (and the sets of bandpass filters could be labelled in the same way). Only three qubits 411-413 have been illustrated in FIG. 4, and no bandpass filters have been illustrated to preserve clarity. Nevertheless, each qubit is coupled with one x-bandpass filter to an x-driveline, with one y-bandpass filter to a y-driveline and with one z-bandpass filter to a z-driveline. The x-, y- and z-drivelines form a three-dimensional cubic grid in this case. One qubit may be arranged within the boundaries of each cube and coupled to the drivelines which delimit that cube. The array can be expanded according to the same logic as the one in FIG. 3 while preserving the possibility to address all qubit combinations.

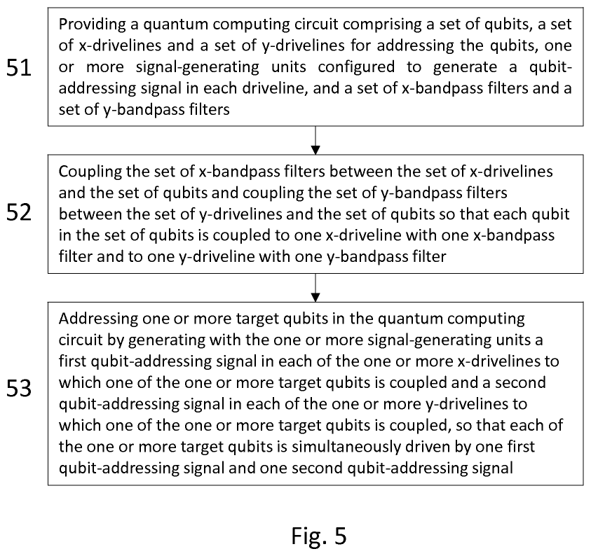

FIG. 5 illustrates the method for addressing one or more target qubits when each qubit in the set is coupled only to one x-driveline and to one y-driveline. The need to address a specific subset of qubits in the array arises on a regular basis when a quantum computer is used. The subset which should be addressed at a given time includes the so-called target qubits. The rest of the qubits (which should not be addressed at that time) may be called non-target qubits. The qubits contained in the target qubit subset changes with time. In other words, a qubit which is one of the target qubits in a addressing procedure performed at time T may be a non-target qubit in the next addressing procedure performed at time T+1. The subset of qubits which is addressed in the method described in this disclosure can be freely selected from the set of qubits. As explained earlier, the driveline grid described in this disclosure facilitates unique addressing of any combination of qubits (i.e. any group of target qubits) included in the array. The method illustrated in FIG. 5 can therefore be implemented for addressing any group of target qubits.

In step 51 in FIG. 5, the following is provided or prepared: a quantum computing circuit comprising a set of qubits, a set of x-drivelines and a set of y-drivelines for addressing the qubits, one or more signal-generating units configured to generate a qubit-addressing signal in each driveline, and a set of x-bandpass filters and a set of y-bandpass filters.

In step 52, the set of x-bandpass filters is coupled between the set of x-drivelines and the set of qubits and the set of y-bandpass filters is coupled between the set of y-drivelines and the set of qubits, so that each qubit in the set of qubits is coupled to one x-driveline with one x-bandpass filter and to one y-driveline with one y-bandpass filter.

In step 53, one or more target qubits in the quantum computing circuit are addressed by generating with the one or more signal-generating units a first qubit-addressing signal in each of the one or more x-drivelines to which one of the one or more target qubits is coupled and a second qubit-addressing signal in each of the one or more y-drivelines to which one of the one or more target qubits is coupled, so that each of the one or more target qubits is simultaneously driven by one first qubit-addressing signal and one second qubit-addressing signal.

The method can be extended to circuits where each qubit is also connected to a z-driveline, as mentioned above. This option has not been separately illustrated. Furthermore, all device options that were described above with reference to FIGS. 1a-1b, 2a-2b, 3 and 4 apply also to the methods where one or more target qubits are addressed.

1. A quantum computing circuit comprising a set of qubits, wherein each qubit in the set has an excitation frequency and the quantum computing circuit comprises drivelines for addressing the qubits in the set and one or more signal-generating units for generating a qubit-addressing signal in each driveline,
characterized in that the drivelines comprise one or more x-drivelines and one or more y-drivelines, and the quantum computing circuit comprises a set of bandpass filters, and the set of bandpass filters comprises a set of x-bandpass filters coupled between the one or more x-drivelines and the set of qubits and a set of y-bandpass filters coupled between the one or more y-drivelines and the set of qubits, so that each qubit in the set of qubits is coupled to one x-driveline with one x-bandpass filter and to one y-driveline with one y-bandpass filter.

2. A quantum computing circuit according to claim 1, wherein the drivelines also comprise one or more z-drivelines, and the set of bandpass filters also comprises a set of z-bandpass filters coupled between the one or more z-drivelines and the set of qubits, so that each qubit in the set of qubits is also coupled one z-driveline with one z-bandpass filter.

3. A quantum computing circuit according to claim 2, wherein the one or more x-drivelines, the one or more y-drivelines and the one or more z-drivelines lie in a driveline plane.

4. A quantum computing circuit according to claim 2, wherein the one or more x-drivelines and the one or more y-drivelines lie in a driveline plane, and the one or more z-drivelines extend against the driveline plane at nonzero angles.

5. A quantum computing circuit according to claim 1, wherein all qubits in the set of qubits have the same excitation frequency.

6. A quantum computing circuit according to claim 1, wherein the set of qubits comprises a first subset of qubits which have a first excitation frequency and a second subset of qubits which have a second excitation frequency.

7. A quantum computer or quantum computing system comprising a quantum-computing circuit according to claim 1.

8. A method for addressing one or more target qubits in a quantum computing circuit comprising a set of qubits, wherein the set of qubits comprises the one or more target qubits, and wherein the quantum computing circuit comprises drivelines for addressing the qubits in the set and one or more signal-generating units configured to generate a qubit-addressing signal in each driveline,
characterized in that the drivelines comprise one or more x-drivelines and one or more y-drivelines, and the quantum computing circuit comprises a set of bandpass filters, and the set of bandpass filters comprises a set of x-bandpass filters coupled between the one or more x-drivelines and the set of qubits and a set of y-bandpass filters coupled between the one or more y-drivelines and the set of qubits, so that each qubit in the set of qubits is coupled to one x-driveline with one x-bandpass filter and to one y-driveline with one y-bandpass filter,
and in that the method comprises the step of generating with the one or more signal-generating units a first qubit-addressing signal in each of the one or more x-drivelines to which one of the one or more target qubits is coupled and a second qubit-addressing signal in each of the one or more y-drivelines to which one of the one or more target qubits is coupled, so that each of the one or more target qubits is simultaneously driven by one first qubit-addressing signal and one second qubit-addressing signal.

9. A method according to claim 8, wherein the drivelines also comprise one or more z-drivelines, and the set of bandpass filters also comprises a set of z-bandpass filters coupled between the one or more z-drivelines and the set of qubits, so that each qubit in the set of qubits is also coupled one z-driveline with one z-bandpass filter,
and the method also comprises the step of generating with the one or more signal-generating units a third qubit-addressing signal in each of the one or more z-drivelines to which one of the one or more target qubits is coupled, so that each of the one or more the target qubits is simultaneously driven by one first qubit-addressing signal, one second qubit addressing signal and one third qubit-addressing signal.

10. A method according to claim 9, wherein the one or more x-drivelines, the one or more y-drivelines and the one or more z-drivelines lie in a driveline plane.

11. A method according to claim 9, wherein the one or more x-drivelines and the one or more y-drivelines lie in a driveline plane, and the one or more z-drivelines extend against the driveline plane at nonzero angles.

12. A method according to claim 8, wherein all qubits in the set of qubits have the same excitation frequency.

13. A method according to claim 8, wherein the set of qubits comprises a first subset of qubits which have a first excitation frequency and a second subset of qubits which have a second excitation frequency.
